(19) United States
(12) Patent Application Publication
(10) Pub. No.: US 2007/0144761 A1
(43) Pub. Date: Jun. 28, 2007

(54) Electromagnetically shielded cable

(76) Inventors: Duk Sil Kim, Suwon-si (KR); Hyun Don Kim, Anyang-si (KR); Dong Hyun Kim, Uiwang-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/526,529

(22) Filed: Sep. 25, 2006

(30) Foreign Application Priority Data
Dec. 28, 2005 (KR) 10-2005-0131193

(51) Int. Cl. H01B 7/18

(52) U.S. Cl. 174/102 R

(57) ABSTRACT

Provided is an electromagnetic shielding cable. The electromagnetic shielding cable comprises one or more cores made of a conductive material, an insulating layer surrounding the cores, and an electromagnetic shielding material surrounding the insulating layer. The electromagnetic shielding material has a nonconductive material and a conductive soft magnetic material coated on the nonconductive layer.

### CROSS-REFERENCE TO RELATED PATENT APPLICATION

This application claims the benefit of Korean Patent Application No. 10-2005-0131193, filed on Dec. 28, 2005, in the Korean Industrial Property Office, the disclosure of which is incorporated herein by reference in its entirety.

### BACKGROUND

1. Field of the Invention

The present invention relates to a shielded cable and, more particularly, to an electromagnetically shielded cable.

2. Description of the Related Art

Digital electronic equipments such as computers or various communication equipments are composed of numerous electronic components including RAMs, ROMs, microprocessors and the like. These electronic components include a plurality of logic devices and are mounted on a printed wiring board (PWB) on which signal lines are wired. Signals flow inside or between the components. The signals which are accompanied by sharp changes of voltage or current may cause generation of electromagnetic noise. Such electromagnetic noise may adversely affect communication cables connecting electronic components. Therefore, electromagnetic shielding cables are used.

### SUMMARY OF CERTAIN INVENTIVE ASPECTS

An aspect of the invention provides an electromagnetically shielded cable, which may comprise: at least one conductive core; an insulator substantially surrounding the at least one conductive core; and an electromagnetic shield substantially surrounding the insulator, the electromagnetic shield comprising an electrically nonconductive material coated with a soft magnetic material.

In the foregoing cable, the nonconductive material may form a layer comprising two opposing surfaces, and wherein the soft magnetic material may be formed on one or both of the two opposing surfaces. At least part of the soft magnetic material may be interposed between the nonconductive material and the insulator. The electromagnetic shield may further comprise a third material layer between the nonconductive material and the soft magnetic material. The third material layer may comprise a seed layer for electroless plating of the soft magnetic material on the nonconductive material. The nonconductive material may comprise one or more selected from the group consisting of non-woven fabric, woven fabric, paper and polymeric films. The soft magnetic material may comprise one or more selected from the group consisting of Ni—Co, Fe—Ni, Fe—Cr, Fe—Al, Fe—Si, Ni—Zn ferrite and Mn—Zn ferrite. The electromagnetic shield may be formed by plating the soft magnetic material on a surface of the nonconductive material. The soft magnetic material may be coated in a thickness from about 0.03 to about 1 mm.

Still in the foregoing cable, the at least one conductive core may be a single wire. The at least one conductive core may comprise a bundled plurality of wires. The insulator may comprise an electrically nonconductive resin. The insulator may have a thickness from about 0.01 to about 0.5 mm. The electromagnetic shield may have a thickness from about 0.03 to about 1 mm. The at least one conductive core, the insulator and the electromagnetic shield may be substantially coaxially arranged. The cable may be substantially flexible.

Another aspect of the invention provide a method of making an electromagnetically shielded cable, which may comprise: providing at least one conductive core substantially surrounded by an insulator; providing a sheet comprising an electrically nonconductive material coated with a soft magnetic material; and surrounding the at least one conductive core and the insulator with the sheet.

In the foregoing method, providing the sheet may comprise providing the nonconductive material, and plating the soft magnetic material on a surface of the nonconductive material. Plating the soft magnetic material may comprise electroless plating. Plating may comprise forming a seed layer on the nonconductive material. The soft magnetic material may be interposed between the nonconductive material and the insulator. The nonconductive material may comprise one or more selected from the group consisting of non-woven fabric, woven fabric, paper and polymeric films. The soft magnetic material may comprise one or more selected from the group consisting of Ni—Co, Fe—Ni, Fe—Cr, Fe—Al, Fe—Si, Ni—Zn ferrite and Mn—Zn ferrite.

Still another aspect of the invention provides a method of shielding a cable from electromagnetic interference, which may comprise: providing the foregoing cable under an environment where electromagnetic propagations exist; and wherein the electromagnetic shield substantially shields at least some external electromagnetic interference that could inflict to the core but for the electromagnetic shield.

In accordance with an aspect of the present invention, an electromagnetic shielding cable may comprise one or more cores made of a conductive material; an insulating layer surrounding the cores; and an electromagnetic shielding layer surrounding the insulating layer, formed of an insulator containing a conductive soft magnetic material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of an electromagnetic shielding cable; and

FIG. 2 is a schematic cross-sectional view of an electromagnetic shielding cable in accordance with one embodiment of the present invention.

### DETAILED DESCRIPTION OF EMBODIMENTS

Now, embodiments of the present invention will be described in detail with reference to accompanying drawings such that those skilled in the art can easily practice the present invention. However, these embodiments are provided only for illustrating the present invention and should not be construed as limiting the scope and spirit of the present invention.

An electromagnetic shielding cable, which can also be referred as the electromagnetically shielded cable, has a structure including one or more cores made of a conductive material, an insulating layer surrounding the cores, and conductive electromagnetic shielding layer surrounding the insulating layer. The insulating layer is surrounded by the electromagnetic shielding layer made of a conductive material to block electromagnetic noise from external sources, thereby resulting in prevention of malfunctions or operating errors of the devices due to interference of electromagnetic noise. Here, the electromagnetic shielding layer may be formed using a variety of conductive materials such as metals, conductive polymers having semiconductive properties or electrically conductive resin materials in which conductors such as metals or alloys are dispersed in polymers.

Such electromagnetic shielding cables can shield the core from electromagnetic noise from the outside, but electromagnetic noise emitted from the inside of the cables may cause problems. Taking into consideration such problems, an electromagnetic shielding cable which not only blocks electromagnetic waves from the outside but also can prevent electromagnetic waves from being emitted from the cable is needed.

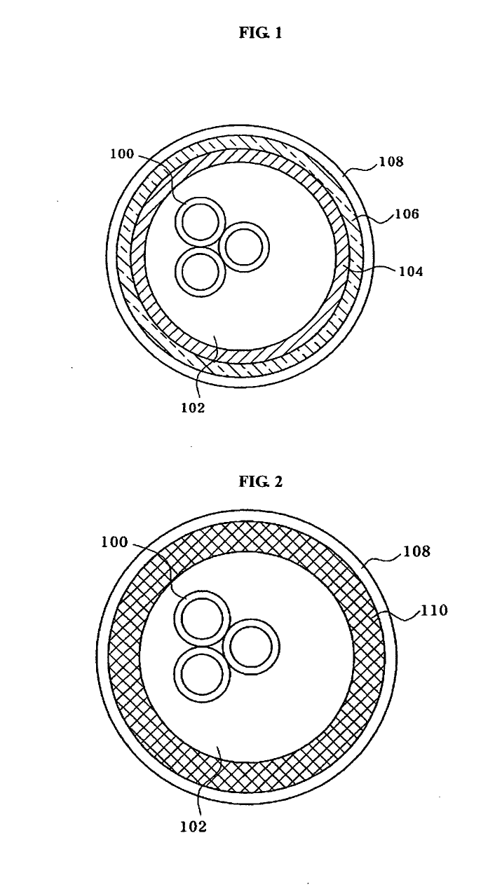

The constitution of an electromagnetic shielding cable is schematically shown in FIG. 1. Referring now to FIG. 1, an electromagnetic shielding cable has a structure including one or more cores 100 made of a conductive material, an insulating layer or insulator 102 surrounding the cores 100, a composite magnetic material layer 104 surrounding the insulating layer 102, a conductive electromagnetic shielding layer 106 surrounding the composite magnetic material layer 104 and a protective outer coat 108 surrounding the conductive electromagnetic shielding layer 106. The composite magnetic material layer 104 is made of a material in which soft magnetic material powder is mixed with an organic binder such as ABS resin.

According to the above electromagnetic shielding cable, the conductive electromagnetic shielding layer 106 enables shielding of electromagnetic noise from the outside and at the same time, further blocking electromagnetic waves emitted from the inside of the cable. However, the above electromagnetic shielding cable may suffer from disadvantages. The cable may have an unsatisfactory level of blocking extraneous emission of electromagnetic waves from the outside and the cable may need the formation of two separate layers including the composite magnetic material layer 104 and conductive electromagnetic shielding layer 106, thereby causing complicated manufacturing processes and increased production costs.

FIG. 2 schematically shows a cross-sectional view of an electromagnetic shielding cable in accordance with one embodiment of the present invention. Referring to FIG. 2, the electromagnetic shielding cable in accordance with one embodiment of the present invention includes one or more cores 100 formed of a conductive material and an insulating layer 102 surrounding the cores 100. The electromagnetic shielding cable may be used as any communication cables or power cables which transmit signals or electrical power to a variety of electronic equipments. The configuration of the cores 100 and insulating layer 102 may vary for the application purpose of the cable. For example, where the above electromagnetic shielding cable is applied for a communication cable that connects certain electronic equipments, the cores 100 may be made of a metal material and the insulating layer 102 may be made of polyvinyl chloride (PVC).

In the illustrated embodiment, the electromagnetic shielding cable includes an electromagnetic shielding layer 110 surrounding the insulating layer 102. In an embodiment, the electromagnetic shielding layer 110 is formed of an insulating layer and a conductive soft magnetic material. The conductive soft magnetic material allows the electromagnetic shielding layer 110 to have magnetic characteristics in combination with conductivity. The conductivity of the electromagnetic shielding layer 110 may provide effective shielding from electromagnetic waves transferred from the outside and at the same time, magnetic characteristics of the electromagnetic shielding layer 110 may provide highly efficient absorption of electromagnetic waves emitted from the inside of the electromagnetic shielding cable. Although it will be specifically described in the following examples, the inventors have found that the electromagnetic shielding cable including the electromagnetic shielding layer 110 can exert have a significantly improved electromagnetic shielding effects.

In an embodiment, the electromagnetic shielding layer 110 may be formed of an insulating or nonconductive sheet coated with a conductive soft magnetic material. The electromagnetic shielding cable including the electromagnetic shielding layer 110 provides benefits, such as simplified manufacturing processes and reduced production costs.

Meanwhile, “Soft magnetic materials” are those materials that are easily magnetized and demagnetized. Soft magnetic materials typically have intrinsic coercivity less than 1000 Am⁻¹. Soft magnetic materials are used primarily to enhance and/or channel the flux produced by an electric current. The main parameter, often used as a figure of merit for soft magnetic materials, is the relative permeability (μᵣ, where μᵣ=B/mₒH), which is a measure of how readily the material responds to the applied magnetic field. The other main parameters of interest are the coercivity, the saturation magnetization and the electrical conductivity.

In an embodiment, a metal soft magnetic material or ferrite may be used as the conductive soft magnetic material. In certain embodiments, more specifically, the metal soft magnetic material includes Ni—Co, Fe—Ni, Fe—Cr, Fe—Al and Fe—Si, and the ferrite includes Ni—Zn ferrite and Mn—Zn ferrite, although not limited thereto. Any other soft magnetic materials or ferrites that have conductivity may be utilized.

In certain embodiments, as the nonconductive sheet, fabrics or analogues thereof such as fabrics, paper, non-woven fabrics and polymer films may be used, although not limited thereto. Any material in the form of fabric or analogue thereof may also be utilized as the nonconductive sheet, in other embodiments.

The electromagnetic shielding layer 110, in certain embodiments, may be formed by plating the nonconductive material sheet with a soft magnetic material. In embodiments, the soft magnetic material is plated using electroless plating techniques. In one embodiment, the nonconductive material sheet is pretreated to form a seed layer for the electroless plating thereon. Then, the nonconductive material sheet with the seed layer is plated in a plating bath containing the soft magnetic material. In one embodiment, pretreating of the nonconductive material sheet for the seed layer may involve dipping the nonconductive material sheet into a solution containing a material for the seed layer. The pretreating may comprise a single dipping or multiple dippings to form a single layered seed or multiple layered seed. In one embodiment, the nonconductive material sheet is dipped into an alkali solution containing, for example, NaOH or KOH. Additionally or alternatively, the nonconductive material sheet is dipped into a solution containing Pd catalyst. One of ordinary skill in the appropriate technology will appreciate plating of the soft magnetic material including the electroless plating with formation of seed layers and will be able to design appropriate conditions of the plating in view of different plating parameters.

As described above, by fabricating the electromagnetic shielding layer 110 by way of plating of the conductive soft magnetic material on the nonconductive sheet, it is possible to achieve the enhanced electromagnetic shielding effect and at the same time, it is also possible to very easily manufacture the electromagnetic shielding layer 110.

Meanwhile, the electromagnetic shielding cable may further include a protective outer coat 108 surrounding the electromagnetic shielding layer. The protective outer coat 108 may be formed of resin materials and serves to protect the electromagnetic shielding cable against moisture or pressure of the outside. However, the protective outer coat may be omitted in the electromagnetic shielding cable and therefore the protective outer coat is optionally included therein only when it is necessary to protect the electromagnetic shielding cable from a variety of external environmental factors.

Now, examples will be described. These examples are provided only for illustrating the present invention and should not be construed as limiting the scope and spirit of the present invention.

### EXAMPLE 1

An insulating layer (polyvinyl chloride (PVC) layer) was formed around cores made of a conductive material. Next, a Ni—Co soft magnetic material was plated on a fabric to form an electromagnetic shielding sheet, and then the insulating layer was surrounded by the sheet, thereby preparing an electromagnetic shielding cable in accordance with Example 1.

### EXAMPLE 2

An insulating layer (polyvinyl chloride (PVC) layer) was formed around cores made of a conductive material. Next, a Fe—Ni soft magnetic material was plated on a fabric to form an electromagnetic shielding sheet, and then the insulating layer was surrounded by the sheet, thereby preparing an electromagnetic shielding cable in accordance with Example 2.

### EXAMPLE 3

An insulating layer (polyvinyl chloride (PVC) layer) was formed around cores made of a conductive material. Next, a composite magnetic material was prepared by spraying a soft magnetic material on the polymer layer to surround the insulating layer. Then, a copper-containing conductive electromagnetic shielding layer was formed around the resulting composite magnetic material layer, thereby preparing an electromagnetic shielding cable in accordance with Example 3.

### EXAMPLE 4

An insulating layer (polyvinyl chloride (PVC) layer) was formed around cores made of a conductive material. Then, a copper-containing conductive electromagnetic shielding layer was formed around the insulating layer, thereby preparing an electromagnetic shielding cable in accordance with Example 4.

For electromagnetic shielding cables of Examples 1 to 4, the shielding capability from electromagnetic waves from the outside was measured. Tests were conducted according to KEC method described in the article titled “Evaluations of the Electromagnetic Shielding Effectiveness,” Eizo Hariya, which is incorporated herein by reference. KEC method has been used for measuring the SE (Shielding Effectiveness) value of shielding material. In this measurement, shielding capability of electric field and magnetic field in a frequency of 800 MHz was compared between the electromagnetic shielding cables prepared in Examples 1 to 4. The results thus obtained are shown in Table 1 below.

TABLE 1

| Example No. | Electric field | Magnetic field |
|---|---|---|
| Example 1 | 80 | 80 |
| Example 2 | 60 | 60 |
| Example 3 | 40 | 40 |
| Example 4 | 45 | 45 |

As can be seen from the results of Table 1, the electromagnetic shielding cables of Examples 1 and 2 exhibit significantly improved shielding capability from electromagnetic waves as compared to those of Examples 3 and 4.

As apparent from the above description, in accordance with embodiments of the present invention, it is possible to provide an electromagnetic shielding cable having improved electromagnetic shielding capability. Further, the electromagnetic shielding cable in accordance with embodiments of the present invention leads to simplification in the structure of electromagnetic shielding cable and therefore provides benefits such as simplified manufacturing processes and reduced production costs.

It should be understood that the embodiments and the accompanying drawings have been described for illustrative purposes. Further, those skilled in the art will appreciate that various modifications, additions and substitutions are allowed without departing from the scope and spirit of the invention as set forth in the accompanying claims.

What is claimed is:

1. An electromagnetically shielded cable, comprising:
at least one conductive core;
an insulator substantially surrounding the at least one conductive core; and
an electromagnetic shield substantially surrounding the insulator, the electromagnetic shield comprising an electrically nonconductive material coated with a soft magnetic material.

2. The cable of claim 1, wherein the nonconductive material forms a layer comprising two opposing surfaces, and wherein the soft magnetic material is formed on one or both of the two opposing surfaces.

3. The cable of claim 1, wherein at least part of the soft magnetic material is interposed between the nonconductive material and the insulator.

4. The cable of claim 1, wherein the electromagnetic shield further comprises a third material layer between the nonconductive material and the soft magnetic material.

5. The cable of claim 4, wherein the third material layer comprises a seed layer for electroless plating of the soft magnetic material on the nonconductive material.

6. The cable of claim 1, wherein the nonconductive material comprises one or more selected from the group consisting of non-woven fabric, woven fabric, paper and polymeric films.

7. The cable of claim 1, wherein the soft magnetic material comprises one or more selected from the group consisting of Ni—Co, Fe—Ni, Fe—Cr, Fe—Al, Fe—Si, Ni—Zn ferrite and Mn—Zn ferrite.

8. The cable of claim 1, wherein the electromagnetic shield is formed by plating the soft magnetic material on a surface of the nonconductive material.

9. The cable of claim 1, wherein the soft magnetic material is coated in a thickness from about 0.03 mm to about 1 mm.

10. The cable of claim 1, wherein the at least one conductive core is a single wire.

11. The cable of claim 1, wherein the at least one conductive core comprises a bundled plurality of wires.

12. The cable of claim 1, wherein the insulator comprises an electrically nonconductive resin.

13. The cable of claim 1, wherein the insulator has a thickness from about 0.01 mm to about 0.5 mm.

14. The cable of claim 1, wherein the electromagnetic shield has a thickness from about 0.03 mm to about 1 mm.

15. The cable of claim 1, wherein the at least one conductive core, the insulator and the electromagnetic shield are substantially coaxially arranged.

16. The cable of claim 1, wherein the cable is substantially flexible.

17. A method of making the electromagnetically shielded cable of claim 1, the method comprising:
providing at least one conductive core substantially surrounded by an insulator;
providing a sheet comprising an electrically nonconductive material coated with a soft magnetic material; and
surrounding the at least one conductive core and the insulator with the sheet.

18. The method of claim 17, wherein providing the sheet comprises:
providing the nonconductive material; and
plating the soft magnetic material on a surface of the nonconductive material.

19. The method of claim 18, wherein plating the soft magnetic material comprises electroless plating.

20. The method of claim 17, wherein plating comprises forming a seed layer on the nonconductive material.

21. The method of claim 17, wherein the soft magnetic material is interposed between the nonconductive material and the insulator.

22. The method of claim 17, wherein the nonconductive material comprises one or more selected from the group consisting of non-woven fabric, woven fabric, paper, polymeric films.

23. The method of claim 17, wherein the soft magnetic material comprises one or more selected from the group consisting of Ni—Co, Fe—Ni, Fe—Cr, Fe—Al, Fe—Si, Ni—Zn ferrite and Mn—Zn ferrite.

24. A method of shielding a cable from electromagnetic interference, the method comprising:
providing the cable of claim 1 under an environment where electromagnetic propagations exist; and
wherein the electromagnetic shield substantially shields at least some external electromagnetic interference that could inflict to the core but for the electromagnetic shield.
